(19) United States
(12) Patent Application Publication
(10) Pub. No.: US 2014/0136398 A1
(43) Pub. Date: May 15, 2014

(54) SYSTEM AND METHOD FOR CONSOLIDATING ACCOUNT DATA

(71) Applicants: Charles Brenton Nagel, Dale, TX (US); Steven C. Grey, San Marcos, TX (US)

(72) Inventors: Charles Brenton Nagel, Dale, TX (US); Steven C. Grey, San Marcos, TX (US)

(21) Appl. No.: 12/944,702

(22) Filed: Nov. 11, 2010

Related U.S. Application Data
(63) Continuation-in-part of application No. 12/834,791, filed on Jul. 12, 2010.

(51) Int. Cl. G06Q 40/00; G06F 17/30

(52) U.S. Cl. 705/39; 707/769; 707/E17.014

(57) ABSTRACT

Embodiments include a method of mapping accounts from a plurality of accounting files to a set of standard accounts. In one embodiment, the method includes identifying an account type of a first account having a first account name, mapping the first account to a first one of a plurality of sub accounts of the account type, and combining an amount of the first account with an amount in the first one of the sub accounts.

### PRIORITY

This application is a continuation-in-part of U.S. patent application Ser. No. 12/834,791 filed on Jul. 12, 2010, which is incorporated herein by reference in its entirety.

### FIELD

This written description is in the field of QuickBooks (QB) data processing. More particularly, the written description is in the field of mapping accounts in QB.

### BRIEF DESCRIPTION OF THE DRAWINGS

Aspects of embodiments will become apparent upon reading the following detailed description and upon reference to the accompanying drawings in which like references may indicate similar elements:

FIG. 1 depicts a network and server for aggregating QB data from computers of companies and sub companies;

FIG. 2 depicts a flow chart of a process of setting up QB relationships;

FIG. 3 depicts a flow chart of a process for mapping accounts to standard accounts;

FIG. 4 depicts a flow chart of a process for mapping accounts to standard accounts;

FIG. 5 depicts a flow chart of a process for mapping accounts to standard accounts; and

FIG. 6 depicts a flow chart of a process for mapping accounts to standard accounts.

### DETAILED DESCRIPTION

The following is a detailed description of embodiments depicted in the accompanying drawings. The amount of detail offered is not intended to limit the anticipated variations of embodiments; but, on the contrary, the intention is to cover modifications, equivalents, and alternatives falling within the scope of the appended claims. The detailed descriptions below are designed to make such embodiments obvious to a person of ordinary skill in the art.

Embodiments include a method of mapping accounts from a plurality of accounting files to a set of standard accounts. In one embodiment, the method includes identifying an account type of a first account having a first account name, mapping the first account to a first one of a plurality of sub accounts of the account type, and combining an amount of the first account with an amount in the first one of the sub accounts.

One embodiment is a system for consolidating multiple accounts at remote locations into standard sub accounts at a central location. The system comprises a memory to store data of a plurality of account types, each account type having a plurality of sub accounts. The system also includes a processor in communication with the memory. The processor is configured to identify an account type of a first account having a first account name, map the first account to one of the plurality of sub accounts of the identified account type, and to combine an amount of the first account with an amount in the one of the plurality of sub accounts to which the first account is mapped.

Another embodiment is a computer readable tangible medium having computer instructions that when executed by a processor cause the processor to perform operations, including identifying an account type of a first account having a first account name, and analyzing the first account name to determine to which of a plurality of sub accounts of the account type to map the first account.

Small businesses and accountants need visibility and usability of financial and operational data from remote locations. QuickBooks™ (QB) by Intuit™ currently owns roughly 87% of the small business accounting software installed at computers of companies distributed geographically. However, the QuickBooks software does not allow for aggregation and consolidation of disparate files. Only their Enterprise™ solution supports this. However, the Enterprise solution involves difficult processes and only applies to Enterprise-formatted company files. Most QuickBooks users do not run Enterprise due to a lack of need for the features it provides and because of its high cost. If a company has multiple QuickBooks files with users needing to access data contained in more than one QB file, one option is to open each QB file, export a large number of reports to Microsoft™ Excel™ and then map the account names of each QB file, combine the data, create custom analytics to measure results, create charts and graphs for better understanding and transmit the results to users. This process is extremely manually intensive and in many cases prohibitive due to the large number of QB files that may exist. For instance, a franchise might have 50, 200 or even 30,000 QB files in its network of businesses located across the globe.

Further complicating the process is the fact that versions of QB are not backward compatible. For example, if a user runs QB 2008 Premier™, then opening a file in a later version of QB will convert the file to the later version and the file can then not be opened using the earlier version of QB.

Also, a typical QB file contains many user created items such as the chart of accounts, lists of customers and vendors, inventory items, etc. These files can be structured any way the user wishes to represent their company's data. Therefore, the naming conventions, structure and organization of these items can vary widely between QuickBooks files.

A desired objective is to be able to consolidate, as well as compare, the financial reports of multiple QB files. Consolidating reporting of multiple QuickBooks files without a common structure creates a large and incomparable chart of accounts, list of customers and vendors, inventory items, and other user created items. Currently, the only way for a user with multiple files to consolidate the files involves manually exporting the data from each QuickBooks file to a different format (i.e. excel, csv, etc), then adding or deleting rows or columns or renaming items in an attempt to “map” the results into a standard destination format. Then, the results of each exported file would need to be added together to get a consolidated report in the standard format. It is highly likely that no two QB files would have the exact same account structure, which means that a very manually intensive process is required to “map” every line of every report to the standard format. Depending on the number of files this can be an extremely difficult and time consuming task.

Embodiments described herein provide a mapping technology to consolidate files into a standard chart of accounts, list of customers/vendors or inventory items, etc. The mapping tool attempts to sort the accounts into different destination accounts that may be system defined or user defined without requiring the user to modify the underlying data in each file. The mapping tool uses information associated with accounts to make intelligent destination mapping choices. For example, software such as QuickBooks (QB) associates each account with an account type. The account type of an account can be used to see which group of destination mapped items the account belongs to. The system will attempt to map the accounts based on the name automatically, but the user can manually make changes to the mapping. In some embodiments, items with ambiguous or unfamiliar names may be mapped by the end user. A destination mapping is associated with a unique identifier provided by QuickBooks. In the future, if the user changes the name of an account that is mapped to a particular destination, the newly named account will be mapped to the same destination as before.

The mapping is used to presenting a unified chart of accounts, customer or vender list, inventory control system, etc for the purposes of creating financial reports and performing business analysis. This may include benchmarking, early warning alerts or projective analysis tools and creates a common structure for items across other files. The result of the mapping techniques described herein is a highly scalable solution which can pull data from a large number of files, attempt to map each to a defined standard format and allow users to consolidate results or compare many businesses' results in a common format without the need to actually change the original chart of accounts. Although the examples herein apply to QuickBooks accounts, the methods and systems described herein may be applied to other financial accounting software.

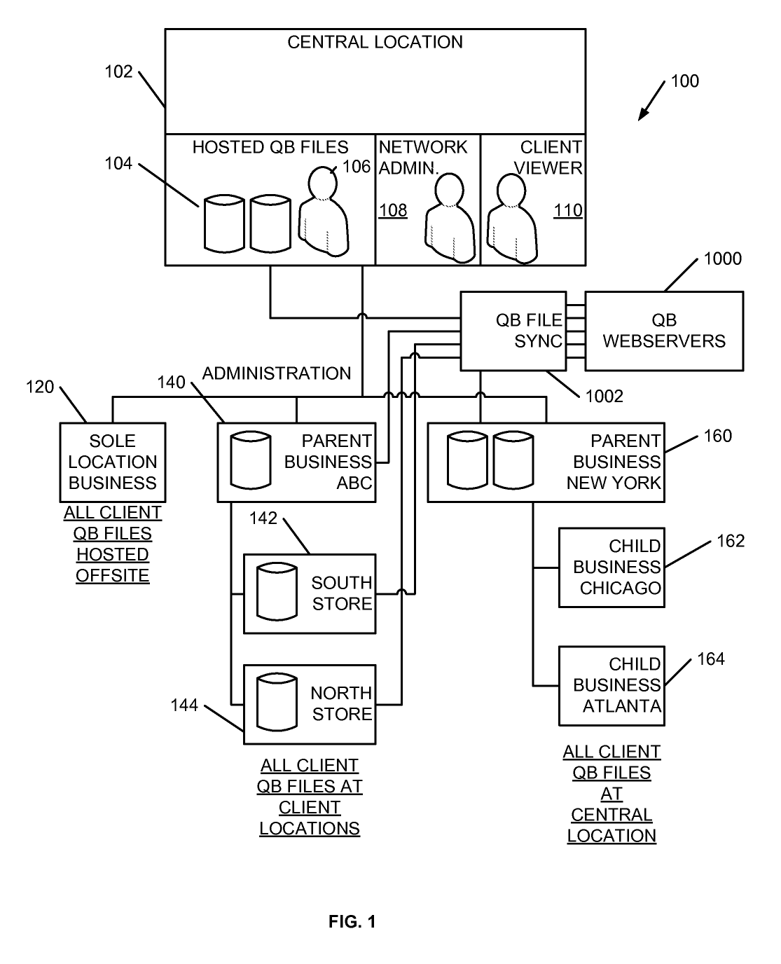

FIG. 1 depicts a network and server for aggregating QB data from computers of companies and sub companies. The elements of the network may be connected by a local area network or a wide area network such as the Internet. A virtual or real central location 102, or a distributed network of locations, may be created to operate, and supervise the use of, the processing mechanisms described herein. The central location 102 has access to the QB files of a plurality of companies 120, 140, 160, and the affiliate or child companies of these companies 142, 144, 162, and 164.

Thus, for example, the central location may be at an accounting firm with a great number of client companies, each company having at least one QB file. The company 120, for example, may be a florist shop. The parent business 140 may be a mobile phone store with a south store 142 and a north store 144, where the north and south stores may be located at different locations within a city or state. The parent business 160 may be a law firm with its principal office in New York, and with offices in Chicago, 162, and in Atlanta, 164.

Note that in the case of related businesses 140, 142, and 144, each business' respective QB file is located at the same location as the business. In contrast, in the case of the related businesses 160, 162, and 164, each business' respective QB file is located at a central location at business site 160. Note also, that the QB files of business 120 are located offsite. Virtually any business, having virtually any complex relationships of its sub businesses, may use separate instances of QB at the respective locations of the businesses and sub businesses.

In one embodiment, the central location 102 may access the QB files from these businesses and sub businesses and store them in a database of QB files 104. A contributor 106 may have access to the system only to the extent necessary to maintain the system. A network administrator 108 may set passwords, control access to the system, and perform other administrative functions. For example, the network administrator 108 may grant viewing access to a client viewer 110, enabling the viewer 110 to view aggregated QB data. To enable access to the data, a graphical user interface and a keyboard and a mouse may be provided, as is known in the art.

In one embodiment, QB data is obtained from the plurality of companies, 120, 140, 142, 144, 160, 162, and 164, by at least one server 1000 via a QB synchronization application 1002. The server 1000 may be located at any location connected to the network. In particular, the server 1000 may be located at the central location 102 or at a separate location. The QB synch application 1002 may be downloaded over the network to the business locations where the QB files are located. Thus, for example, the QB synch application 1002 may be downloaded to locations 104, 140 142, 144, and 160, as well as to the central location 102. The synchronization application 1002 may reside at the local QB file locations 104, 140 142, 144, and 160, and may operate to upload transactional data from the QB files at the locations 104, 140 142, 144, and 160. The upload of transactional data may be scheduled by an administrator to occur as often as desired, for example, daily, or the upload can occur upon entry of a command by the administrator.

One embodiment includes a system for consolidating QB accounts from remote locations to a set of standard accounts in a central location. The system includes a memory and a processor. The memory is to store data of a plurality of QB account types, each QB account type having a plurality of sub accounts. The processor is in communication with the memory and is configured to identify a QB account type of a first account having a first account name. The first account is mapped to one of the plurality of sub accounts of the identified QB account type. The processor combines an amount of the first account with an amount in the one of the plurality of sub accounts to which the first account is mapped. In some embodiments, the processor is further configured to examine a character string of the first account to determine the one of the plurality of sub accounts of to which the first account is mapped. The processor may be configured to apply a filter to determine a sub account to which the first account belongs or does not belong.

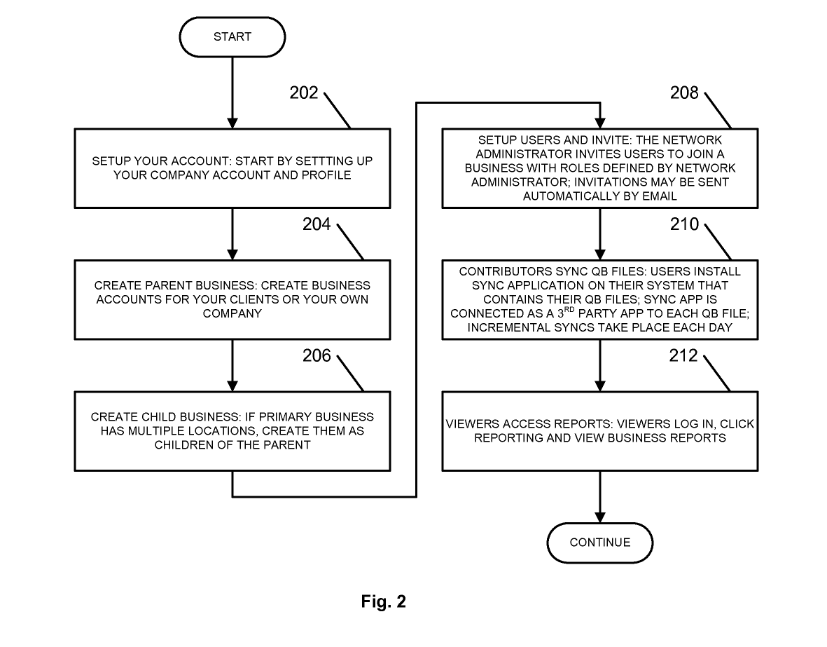

FIG. 2 depicts a flow chart for setting up QB relationships for uploading QB files to a central location and aggregating data from a plurality of QB files of client companies and sub companies. First, an administrator of accounts will set up an account and company profile, at 202. Then, the administrator may create a parent business or client account, at 204. Once a parent client is created, the administrator may create sub businesses or sub clients of the parent client, at 206.

The administrator may then authorize certain contributors to have access to the system, at 208. The administrator invites users to join a business with a defined role. Invitations may be sent automatically by email. An authorized contributor may install a QB synchronization application at a local computer, at 210. The QB synchronization application interfaces with the local QB files of transaction data, and transmits the data from such files to the central location. Once synchronization takes place, authorized viewers may compile and review business reports that reflect data aggregated from QB files of different locations and companies, at 212.

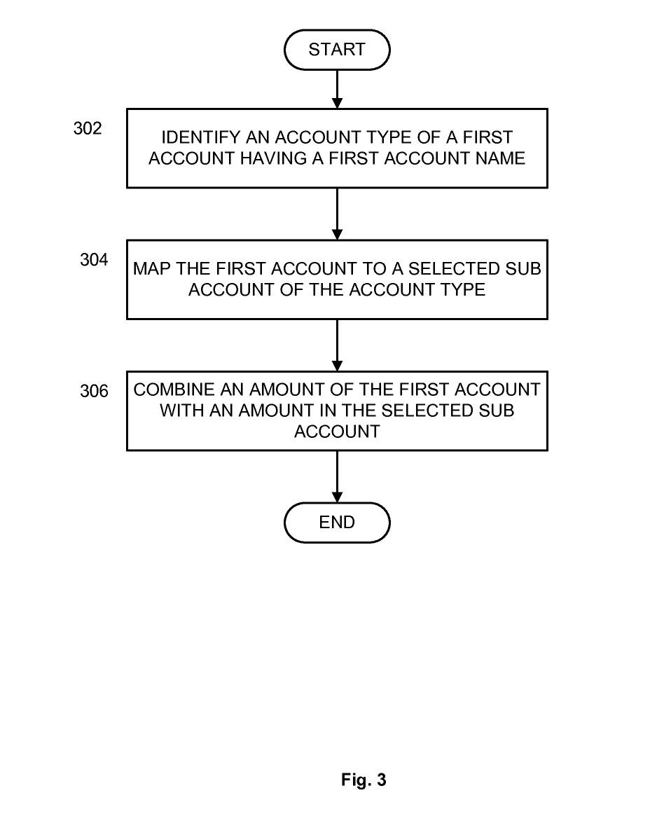

FIG. 3 is a flow chart of a process for mapping differently named accounts to one of a plurality of standard accounts. In a first step, 302, an account type of a first account having a first account name is identified. At 304, the first account is mapped to a selected sub account of the account type. At 306, the amount in the first account is combined with the amount in the selected sub account.

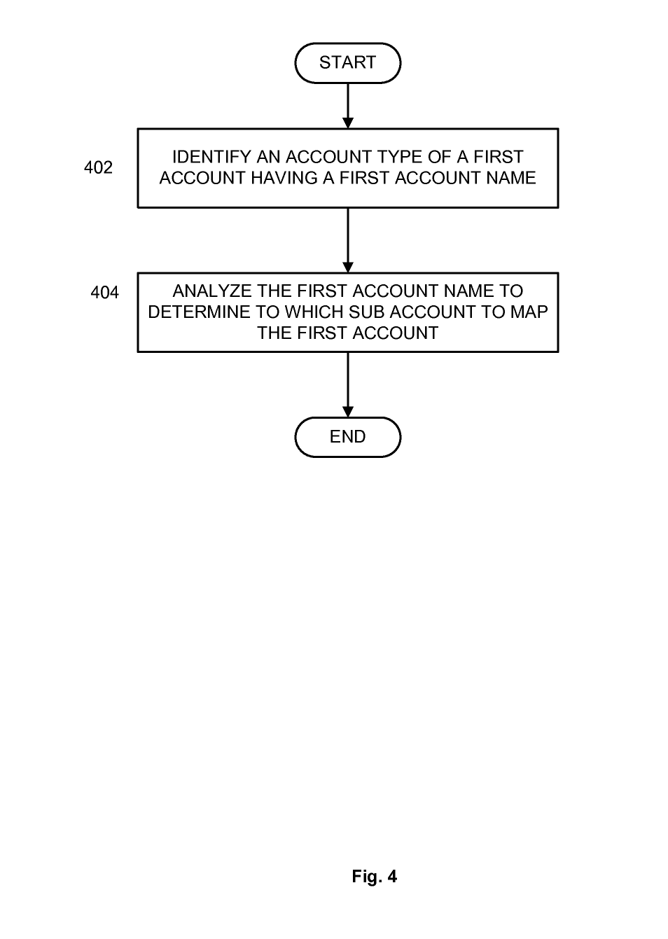

FIG. 4 is a flow chart of a process for mapping differently named accounts to one of a plurality of standard accounts. In a first step 402, an account type of a first account having a first account name is identified. At 404, the first account name is analyzed to determine to which sub account of the account type the first account is mapped.

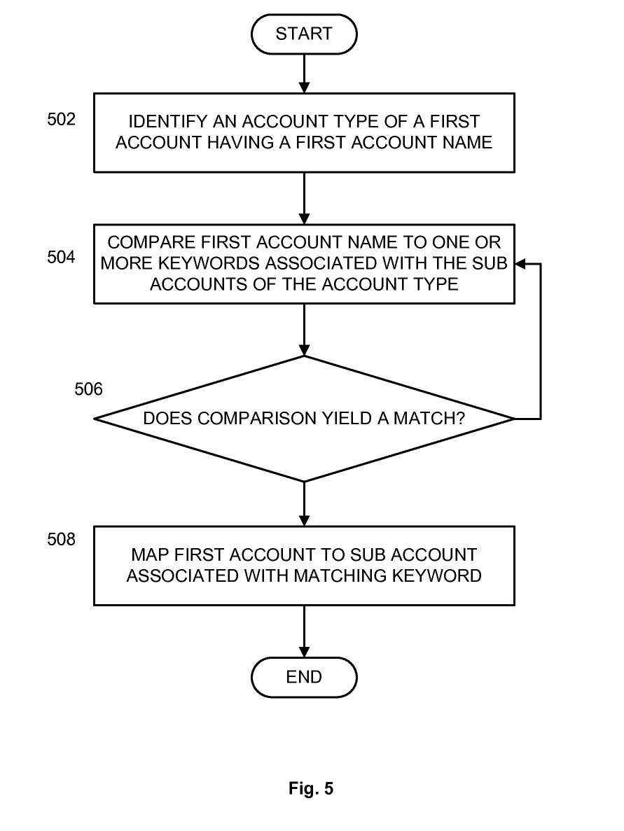

FIG. 5 is a flow chart of a process for mapping differently named accounts to one of a plurality of standard accounts. In a first step 502, an account type of a first account having a first account name is identified. At 504, the first account name is compared to keywords associated with sub accounts of the identified account type. If the first account name, or a portion of the first account name, matches a keyword, at step 506, the first account is mapped to the sub account associated with the matching keyword, at 508.

For example, suppose the account type of an account named “legal” is an expense account type. The name legal may be compared to key words associated with sub accounts of the expense account type. For example, a sub account of the expense type named “professional services” may be associated with the keywords, “accounting,” “legal,” and “medical,” to name just a few. Because the account named “legal” is an expense account and because its name, “legal,” matches a keyword of the sub account named “professional services,” the account named “legal” is mapped to the sub account, “professional services.”

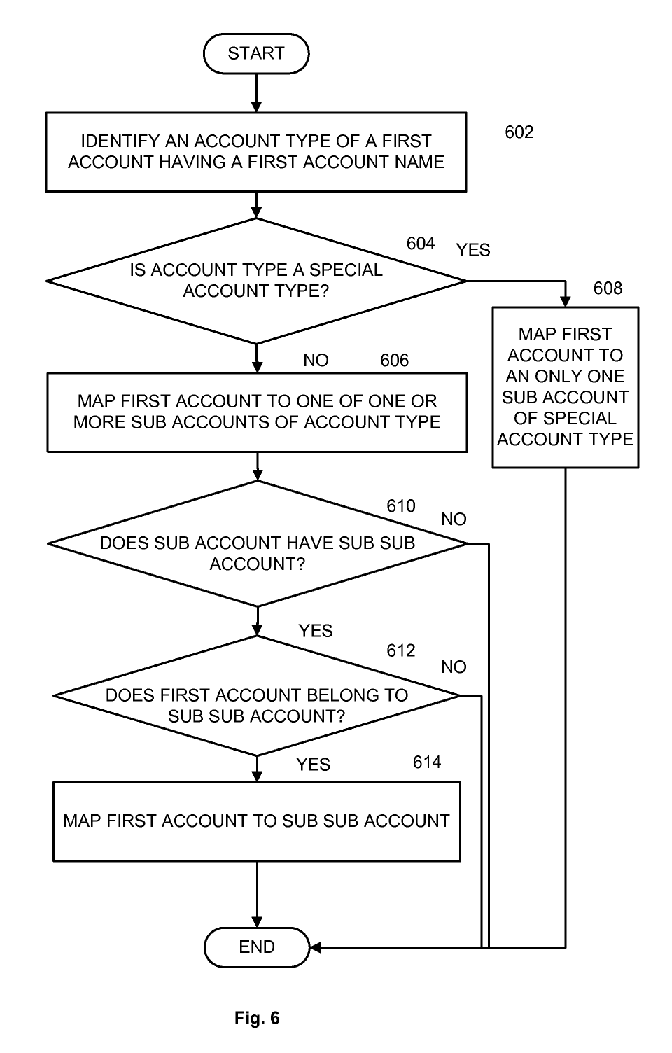

FIG. 6 is a flow chart of a process for mapping differently named accounts to one of a plurality of standard accounts. In a first step 602, an account type of a first account having a first account name is identified. A determination whether the account type is a special account type having only one sub account, is made at step 604. If so, the first account is mapped to the only one sub account of the special account type, at step 608. If the account type is not a special account type, the first account is mapped to one of one or more sub accounts of the account type, at 606. At step 610, whether the one sub account has a sub sub account, is determined. If not, the process ends. If the one sub account does have a sub sub account, then whether the first account belongs to the sub sub account is determined, at 612. If the first account does not belong to the sub sub account the process ends. If the first account does belong to the sub sub account, then the first account is mapped to the sub sub account, at 614.

The following table, Table 1, shows a plurality of account types and their associated sub accounts in one embodiment.

TABLE 1

| ACCOUNT TYPE | SUB ACCOUNT NAME |
|---|---|
| ACCOUNTS RECEIVABLE | ACCOUNTS RECEIVABLE |
| BANK | CASH AND CASH EQUIVALENTS |
| OTHER CURRENT ASSETS | UNDEPOSITED FUNDS |
| | ALLOWANCE FOR DOUTBFUL |
| | ACCOUNTS |
| | INVENTORY |
| | PREPAID EXPENSES |
| | SUPPLIES |
| | DEFERRED INCOME TAXES |
| | MISCELLANEOUS CURRENT ASSETS |
| FIXED ASSET | PROPERTY |
| | PLANT |
| | EQUIPMENT |
| | MISCELLANEOUS FIXED ASSETS |
| | ACUMULATED DEPRECIATION |
| OTHER ASSETS | INTELLECTUAL PROPERTY |
| | GOODWILL |
| | MISCELLANEOUS OTHER ASSETS |
| ACCOUNTS PAYABLE | ACCOUNTS PAYABLE |
| CREDIT CARDS | CREDIT CARD |
| OTHER CURRENT | PAYROLL LIABILITIES |
| LIABILITIES | SALES TAX PAYABLE |
| | WAGES PAYABLE |
| | TAXES PAYABLE |
| | UNEARNED REVENUE |
| | CURRENT PORTION OF LONG TERM |
| | DEBT |
| | ACCRUED EXPENSES |
| | NOTES PAYABLE |
| | INTEREST PAYABLE |
| LONG TERM LIABILITY | NOTES PAYABLE |
| | MORTGAGE PAYABLE |
| | LONG TERM CAPITAL LEASES |
| | BONDS PAYABLE |
| | EMPLOYEE PENSION/BENEFITS |
| | DEFERRED TAXES |
| EQUITY | OPENING BALANCE EQUITY |
| | RETAINED EARNINGS |
| | OWNERS DRAW |
| | OWNERS EQUITY |
| | COMMON STOCK AND ADDITIONAL |
| | PAID IN CAPITAL |
| | PREFERED STOCK AND |
| | ADDITIONAL PAID IN CAPITAL |
| INCOME | SERVICES |
| | PRODUCTS |
| | RENTALS |
| | MISCELLANEOUS INCOME |
| COST OF GOODS SOLD | LABOR |
| | MATERIALS |
| | OVERHEAD |
| | MISCELLANEOUS COGS |
| EXPENSE | ADVERTISING (PROMOTION, |
| | MARKETING |
| | AMORITIZATION/DEPRECIATION |
| | EXPENSE |
| | INSURANCE |
| | INTEREST INCOME |
| | MISCELLANEOUS EXPENSES |
| | OCCUPANCY (RENT, UTILITIES, |
| | REPAIRS) |
| | PAYROLL EXPENSE |
| | PROFESSIONAL SERVICES |
| | TAXES |
| | TRANSPORTATION (AUTO, FUEL, |
| | REPAIRS) |
| OTHER INCOME | UNCATEGORIZED INCOME |
| | INTEREST INCOME |
| | DIVIDEND INCOME |
| | GAIN ON SALE OF ASSET |
| OTHER EXPENSE | UNCATEGORIZED EXPENSE |
| | INTEREST EXPENSE |
| | LOSS ON SALE OF ASSET |
| NON POSTING | ESTIMATES |
| | PURCHASE ORDERS |
| | SALES ORDERS |

In table 1, each account type has at least one sub account. At least some of the account types with only one sub account are special account types. For special account types, there is only one sub account to map to.

As an example, account names of accounts from various remote QB files may include: trees, merchandise sales, services, shrubs, blueprints, medical expenses, legal, repairs, advertising, etc. The following shows a profit and loss table after these account names are mapped to standard sub accounts based on their account types.

Income

Product sales
Service sales
Refunds

Total Income
Cost of Goods Sold
Expenses

Professional services
Technology
Facilities
Payroll
Owner compensation
Advertising

Net Income

In one embodiment the account names of the various QB files in remote locations may be displayed in a first area of a graphical user interface and the standard account types and sub accounts to which the account names may be mapped are displayed in a second area of the graphical user interface, thereby enabling an operator to “drag and drop” each account name to a subaccount to map the account names to the sub accounts using a keyboard and/or mouse.

Thus, some embodiments include a method of aggregating data from a plurality of QB source accounts in remote locations having different account names. The method includes identifying a QB account type of a first account having a first account name. The method includes mapping the first account to a first one of a plurality of sub accounts of the QB account type. An amount in the first account is combined with the first one of the plurality of sub accounts. The account type may be one of a standard QB account type chosen by a manufacturer of the QB program. The QB account type may be a special account type having only one sub account. Also, in some embodiments, when a name of a first mapped account is changed, the sub account to which the first mapped account is mapped remains the same.

Determining the sub account of an account name to which to map an account may be performed in a variety of ways. In one embodiment, a character string of a second account name of a second account to be mapped to a sub account is compared to one or more account names previously mapped to the sub account to determine if there is a match or correlation between the second account name and the previously mapped account name. In some embodiments, a Bayesian filter is applied to a first account name to determine a QB sub account to which the first account is mapped. Also, or alternatively, a Bayesian filter is applied to the first account name to exclude a QB sub account, so that the first account name is not mapped to the excluded sub account. In some embodiments, a first account name is compared to keywords associated with sub accounts of the account type of the first account.

Another illustrative embodiment includes a machine-readable medium embodying machine-readable instructions that, when executed by a processor, cause the processor to perform operations for mapping accounts from files at remote locations to standard accounts at a central location. The operations include identifying a QB account type of a first account having a first account name. The operations also include analyzing the first account name to determine to which of a plurality of sub accounts of the QB account type to map the first account. Analyzing the first account name may include comparing the first account name to keywords associated with the sub accounts and mapping the first account to a sub account associated with a matching keyword. In some embodiments, the operations may further include determining that the QB account type is a special account type having only a single sub account, and adding an amount of the first account to the single sub account. In some embodiments, the operations may further include determining a sub account of the account type has a sub sub account, and determining whether to map the first account to the sub sub account. In some embodiments, the operations may further include applying a filter to exclude sub accounts to which to map the first account.

Various changes, substitutions and alterations can be made to the embodiments described herein without departing from the scope of the appended claims. An embodiment may achieve multiple objectives, but not every embodiment falling within the scope of the attached claims will achieve every objective. Moreover, the scope of the present application is not intended to be limited to the particular embodiments of the process, machine, manufacture, composition of matter, means, methods and steps described in the specification. One of ordinary skill in the art will readily appreciate from this disclosure that processes, machines, manufacture, compositions of matter, means, methods, or steps, presently existing or later to be developed are equivalent to, and fall within the scope of what is claimed. Accordingly, the appended claims are intended to include within their scope such processes, machines, manufacture, compositions of matter, means, methods, or steps.

1. A method of aggregating data from a plurality of source accounts in remote locations having different account names, comprising:
identifying, by a central computer, an account type of a first account having a first account name, the first account name being specified at a remote computer;
mapping, by the central computer, the first account to a first one of a plurality of sub accounts of the identified account type; and
combining, by the central computer into a unified data structure, a value located within a field of the first account with a value located within a field of the mapped first one of the sub accounts.

2. The method of claim 1, wherein the account type is one of a standard account type chosen by a manufacturer of a financial accounting software program.

3. The method of claim 2, wherein a standard account type is one of accounts receivable, bank, other current assets, fixed assets, other assets, accounts payable, credit card, other current liabilities, long term liabilities, equity, income, other income, cost of goods sold, expense, other expense, and non-posting.

4. The method of claim 1, wherein the account type is one of a special account type chosen by a manufacturer of a financial accounting software program.

5. The method of claim 4, wherein the special account type is one of undeposited funds, inventory assets, payroll liabilities, sales tax payable, opening balance equity, retained earnings, payroll expenses, uncategorized income, uncategorized expenses, estimates, purchase orders, and sales orders.

6. The method of claim 1, further comprising applying, by the central computer, a Bayesian filter to the first account name to determine a sub account to which the first account is mapped.

7. The method of claim 1, further comprising applying, by the central computer, a Bayesian filter to the first account name to exclude a sub account to which the first account may be mapped.

8. The method of claim 1, wherein, when the name of the first mapped account that is mapped to a first sub account is changed to a new account name, the first mapped account remains mapped to the first sub account.

9. The method of claim 1, wherein a character string of a second account name of a second account is compared to an account name previously mapped to a sub account, to determine a sub account to which the second account is mapped.

10. A system for consolidating multiple accounts at remote locations into standard sub accounts at a central location, the system comprising:
memory to store data of a plurality of account types, each account type having a plurality of sub accounts;
a processor at the central location in communication with the memory, the processor configured to:
identify an account type of a first account having a first account name, the first account name being specified at a remote location;
map the first account to one of the plurality of sub accounts of the identified account type; and
combine into a set of standard accounts in a central location, a value located within a field of the first account with a value located within a field of one of the plurality of sub accounts to which the first account is mapped.

11. The system of claim 10, wherein the processor is further configured to examine a character string of the first account to determine the one of the plurality of sub accounts to which the first account is mapped.

12. The system of claim 10, wherein the processor is further configured to apply a filter to determine a sub account to which the first account is mapped.

13. The system of claim 12, wherein the filter is a Bayesian filter.

14. The system of claim 10, wherein the mapping is performed automatically without input from a user.

15. A non-transitory computer readable apparatus configured to store a computer program, the computer program comprising a plurality of instructions configured to, when executed:
identify an account type of a first account having a first account name;
analyze the first account name to determine to which of a plurality of sub accounts of the account type to map the first account; and
combine, into a unified data structure disposed at a central location, a value located within a field of the first account with a value located within a field of one of the plurality of sub accounts to which the first account is mapped.

16. The computer readable apparatus of claim 15, wherein the analysis of the first account name further comprises a comparison of the first account name to keywords associated with the sub accounts.

17. The computer readable apparatus of claim 16, wherein the plurality of instructions are further configured to map the first account to a sub account associated with a matching keyword.

18. The computer readable apparatus of claim 15, wherein the plurality of instructions are further configured to:
determine that the account type is a special account type having only one sub account; and
add an amount of the first account to the only one sub account.

19. The computer readable apparatus of claim 15, wherein the plurality of instructions are further configured to:
determine that the sub account to which the first account is mapped has at least one sub sub account; and
determine that the first account is to be mapped to one of the at least one sub sub account.

20. The computer readable apparatus of claim 15, wherein the plurality of instructions are further configured to apply a filter to exclude sub accounts to which to map the first account.

21. A method of aggregating data from a plurality of source accounts in differing locations having different account names, comprising:
identifying an account type of a first account having a first account name, the first account name being specified at a first of the differing locations;
mapping the first account to a first one of a plurality of sub-accounts of the identified account type; and
combining into a unified data structure, a value located within a field of the first account with a value located within a field of the mapped first one of the sub accounts.

22. The method of claim 21, wherein the combining is conducted irrespective of a relative temporal relationship between the first account and the first one of the plurality of sub-accounts.

23. The method of claim 21, wherein at least both the identifying and the combining are conducted at a second of the differing locations.

24. Apparatus configured to consolidate multiple accounts at remote locations into standard sub-accounts at a substantially central location, the apparatus comprising:
storage apparatus configured to store data of a plurality of account types, each account type having a plurality of sub accounts;
a processor in data communication with the storage apparatus, the processor configured to cause the apparatus to:
identify an account type of a first account having a first account name, the first account name being specified at a remote location;
map the first account to one of the plurality of sub accounts of the identified account type; and
combine (i) a value located within a field of the first account, with (ii) a value located within a field of one of the plurality of sub accounts to which the first account is mapped to produce (iii) a combined value;
wherein the apparatus is further configured to place the combined value into one or more standard accounts in the substantially central location.

25. The apparatus of claim 24, wherein the combined value replaces or displaces the value located within a field of one of the plurality of sub accounts to which the first account is mapped.
